(19) United States
(12) Patent Application Publication
(10) Pub. No.: US 2015/0317233 A1
(43) Pub. Date: Nov. 5, 2015

(54) SOFTWARE SYSTEM DEBUGGING DEVICE AND METHOD THEREOF

(71) Applicant: Samsung Electronics Co., Ltd., Suwon-si (KR)

(72) Inventors: Vrind TUSHAR, BANGALORE (IN); Raju Udava SIDDAPPA, Bangalore (IN); Venkata Raju INDUKURI, Bangalore (IN); Dae-Sop PARK, Suwon-si (KR); Jae-Kyu LEE, Seoul (KR); Sang-Il CHOI, Hwaseong-si (KR); Seok-Min HWANG, Seongnam-si (KR)

(21) Appl. No.: 14/699,564

(22) Filed: Apr. 29, 2015

(30) Foreign Application Priority Data
Apr. 30, 2014 (KR) 10-2014-0052334

(51) Int. Cl. G06F 11/36

(52) U.S. Cl. CPC G06F 11/366; G06F 11/3664

(57) ABSTRACT

An apparatus and a method for maximizing debugging performance and reducing memory overhead are provided. The method includes generating a debug protocol packet and transmitting the generated debug protocol packet to a diagnostic device. The debug protocol packet includes reference information for at least one string associated with a debug trace.

### CROSS-REFERENCE TO RELATED APPLICATION(S)

This application claims the benefit under 35 U.S.C. §119(a) of a Korean patent application filed on Apr. 30, 2014 in the Korean Intellectual Property Office and assigned Serial number 10-2014-0052334, the entire disclosure of which is hereby incorporated by reference.

### TECHNICAL FIELD

The present disclosure relates to software system debugging. More particularly, the present disclosure relates to an apparatus and a method for maximizing a debugging performance in a software system.

### BACKGROUND

Embedded systems are designed with a low on-chip Random Access Memory (RAM) and a low processing power to reduce cost and power consumption. To this end, software running on the embedded system should be optimized to utilize less resources. At the same time, it is important to allow room for adding debug information so that failures can be analyzed quickly in order to reduce overall software development cost. General methods for adding debug logs in a software have both memory and performance overheads.

Therefore, a need exists for an apparatus and a method for maximizing a debugging performance in a software system.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for maximizing a debugging performance in a software system.

Another aspect of the present disclosure is to provide an apparatus and a method for reducing memory overhead due to debugging in a software system.

Another aspect of the present disclosure is to provide an apparatus and a method for optimizing debug trace processing and memory in a software system.

According to an aspect of the present disclosure, a method for operating a debugging target device is provided. The method includes generating a debug protocol packet and transmitting the generated debug protocol packet to a diagnostic device. The debug protocol packet comprises reference information regarding at least one string associated with a debug trace.

According to another aspect of the present disclosure, a method for operating a debugging diagnostic device is provided. The method includes receiving debug protocol packet from a target device, extracting at least one string from a pre-input binary file using the received debug protocol packet, and formatting and displaying the extracted string. The debug protocol packet includes reference information regarding the at least one string associated with a debug trace.

According to another aspect of the present disclosure, a target device in a debugging system is provided. The target device includes a processor configured to generate a debug protocol packet and an interface configured to transmit the generated debug protocol packet to a diagnostic device. The debug protocol packet includes reference information regarding at least one string associated with a debug trace.

According to another aspect of the present disclosure, a diagnostic device in a debugging system is provided. The diagnostic device includes an interface configured to receive debug protocol packet from a target device and a debug control module configured to extract at least one string from a pre-input binary file using the received debug protocol packet, and to format and display the extracted string. The debug protocol packet includes reference information regarding the at least one string associated with a debug trace.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates connections of a general debugging processor in an embedded system according to an embodiment of the present disclosure;

FIG. 2 illustrates a logging utility design in an embedded system according to an embodiment of the present disclosure;

FIG. 3 illustrates a random access memory (RAM) layout for an embedded system according to an embodiment of the present disclosure;

FIG. 4 illustrates a debugging system according to an embodiment of the present disclosure;

FIG. 5 is a flowchart illustrating a debugging processing method of a target device according to an embodiment of the present disclosure;

FIG. 6 is a flowchart illustrating a debugging processing method of a diagnostic device according to an embodiment of the present disclosure;

FIG. 7 illustrates constant format string occupancy in a total RAM space according to an embodiment of the present disclosure;

FIG. 8 illustrates constant format string occupancy in a total binary area according to an embodiment of the present disclosure;

FIGS. 9 and 10 illustrate trace strings grouped and placed in a specific memory area according to various embodiments of the present disclosure; and

FIGS. 11, 12, 13, 14, 15, 16, 17, and 18 illustrate reuse of a specific memory area including grouped trace strings according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Since embedded software goes through a cycle of design, implementation, testing, and debugging, it is possible that, during the stage of debugging, it may re-enter the design phase or the implementation phase because of a particular failure. Usually, around 60% of defects exist at the design time, and reworking on the defects consumes around 50-60% of the total software development cost. Software for wireless modems, such as 3^{rd} Generation Partnership Project (3GPP) and Institute of Electrical and Electronics Engineers (IEEE) are designed according to protocol specifications and such software needs to be upgraded with newer features so as to inter-operate and scale up to ever growing market needs. These incremental changes may require additional system resources.

To understand behavior and flow of transactions during the failure, debug traces or prints are added in the code which aid in the debugging. Such traces are transferred to a separate process normally residing on a host Personal Computer (PC) via a debug interface. The debug trace comes with a trade-off in the form of additional memory requirement for static strings included in the prints and processing overhead for transferring the logs through the debug interface.

Thus, various embodiments of the present disclosure reduce the development cost by enabling extensive debugging. This is because a test-debug cycle is expected to be iterated lesser number of times in the debugging. In addition, the various embodiments of the present disclosure create room for the new features to be added to the software by optimizing performance and reducing memory footprint.

The various embodiments of the present disclosure provide an optimization mechanism for reducing the memory overhead by nearly 100% and the processing overhead by over 85%. Through this optimization, it is expected that the development cost will be reduced and systems scalability will be enhanced to meet future incremental requirements. The performance optimization is a requirement for attaining the memory optimization.

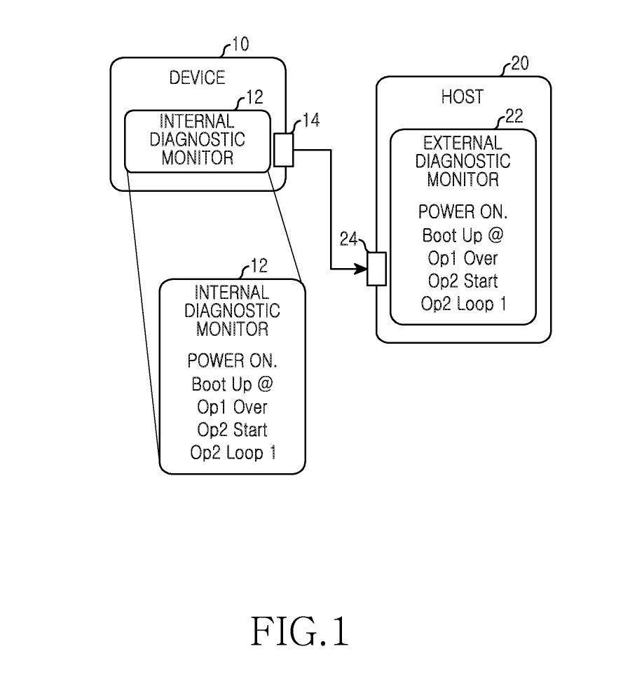

FIG. 1 illustrates connections of a general debugging processor in an embedded system according to an embodiment of the present disclosure.

Referring to FIG. 1, an application program interface (API) in a device 10 transfers the gathered debugging information to a diagnostic monitor (DM) 12 in the same device or to an external DC 22 residing on a host PC 20 through interfaces 14 and 24. The interfaces 14 and 24 can include a serial interface, such as a universal asynchronous receiver/transmitter (UART), a universal serial bus (USB), a standard file input/output (I/O) interface, and the like. The debugging information is generally gathered by adding debug traces in the implementation which invokes an available platform specific logging API.

A typical debug trace can be of the following PRINT statement format:
PRINT (<format string>, <argument list-variable>)

<format string> is a static string, which becomes part of a constant read-only area, or a text area of the binary image. <argument list> indicates run time parameters for the format string.

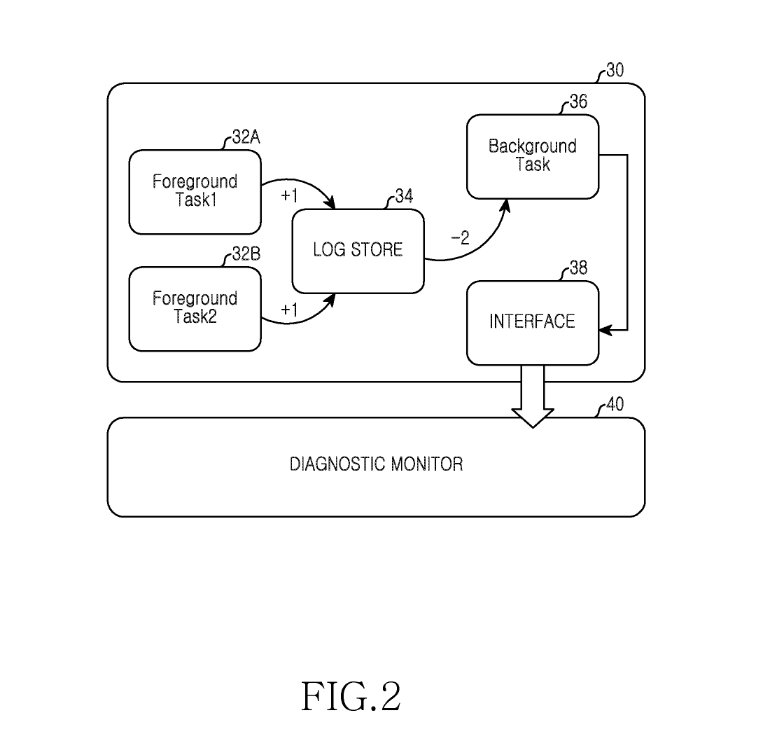

FIG. 2 illustrates a logging utility design in an embedded system according to an embodiment of the present disclosure.

Referring to FIG. 2, a logging interface 38 transfers information formatted in a device 30 to a DM 40. Hence, the formatted information associated with the debugging can be visible on the DM 40. In a standard implementation of PRINT, the debug trace is formatted along with arguments within the device 30, and the formatted information can include a string and the arguments. A log store 34 stores the formatted logs. The logs received through foreground task1 32A and foreground task2 32B and stored in the log store 34 are polled by a background task 36 and transferred to the DM 40 via the logging interface 38.

Such a logging utility design of FIG. 2 can suffer from the following drawbacks.

First, the string formatting within the device can degrade the performance. The string formatting is conducted using PRINT, printf, or similar routines.

Second, the memory can be consumed due to many format strings and constant strings in the whole software. More particularly, the read-only (RO) area of the memory can be consumed.

A program (or a binary image) to be executed in the software system is loaded into a random access memory (RAM) by a boot-loader or an operating system (OS). The boot-loader loading is static loading, and the OS loading is dynamic loading.

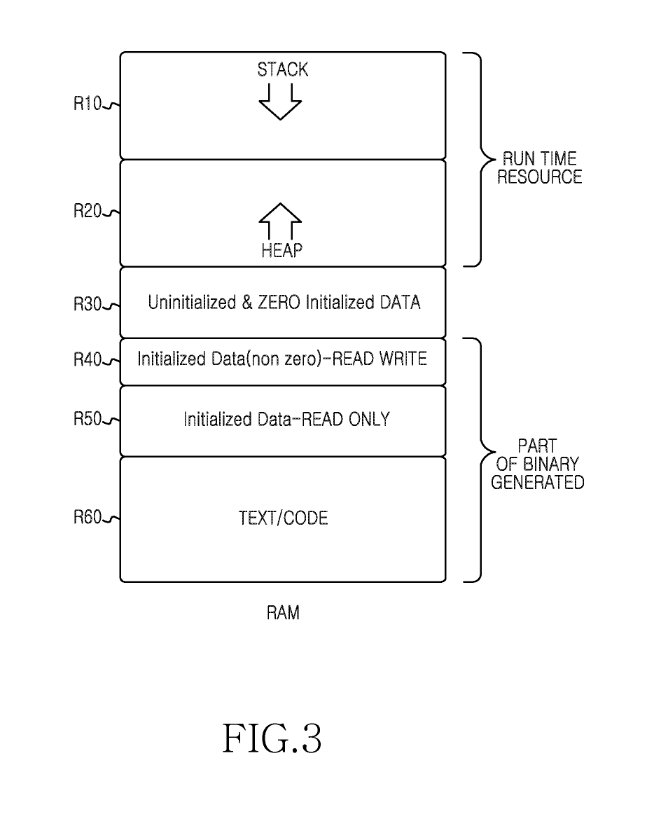

FIG. 3 illustrates a RAM layout for an embedded system according to an embodiment of the present disclosure.

Referring to FIG. 3, the RAM includes areas R10 and R20 for storing run time resources, and other areas R30 through R60. The area R30 stores uninitialized and zero initailized data. The area R40 stores non zero initalized data. The area R40 is a read write area. The area R50 stores the intialized data. The area R50 is the RO area. The area R60 stores text/code. The areas R40 through R60 is part of the generarted binary. The size of the generated binary (the text of the area R60+the data of the areas R40 and R50+ZI (bss) of the area R30) directly affects the available run time resources, such as stack and heap.

Hereinafter, the various embodiments of the present disclosure provide a mechanism for reducing the memory overhead due to the debug trace to nearly zero and considerably reducing the processing overhead in the debugging system. It is advantageous not to restrict a developer from using the debug trace logs in terms of their count and size, and to remove the memory and processing overheads.

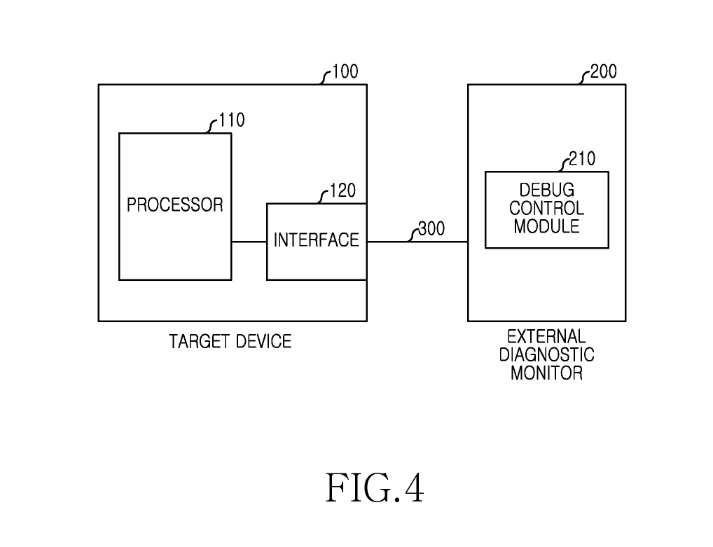

FIG. 4 illustrates a debugging system according to an embodiment of the present disclosure.

Referring to FIG. 4, the debugging system includes a target device 100 and a diagnostic device 200.

The target device 100 stores the software to be executed in the device, which is to be debugged. In general, the target device 100 can employ an integrated circuit (IC) in the format of a system on chip (SoC). For example, the target device 100 can employ a wireless modem chip. The target device 100 includes a processor 110 and an interface 120. The processor 110 includes a memory (e.g., a RAM) for storing the software to be debugged, and a processor core for executing the software stored in the memory. The interface 120 is a component for the data transfer and transfers the debugging information of the target device 100 to the diagnostic device 200 via a link 300. The interface 120 can include a serial interface, such as a UART, a USB, a standard file I/O interface, and the like.

The diagnostic device 200 diagnoses the debug information generated by the target device 100 by running a debug control module 210 for extracting and analyzing the debug information. For example, the diagnostic device 200 can be a host PC residing outside the target device 100. Alternatively, the diagnostic device 200 can be included in the target device 100.

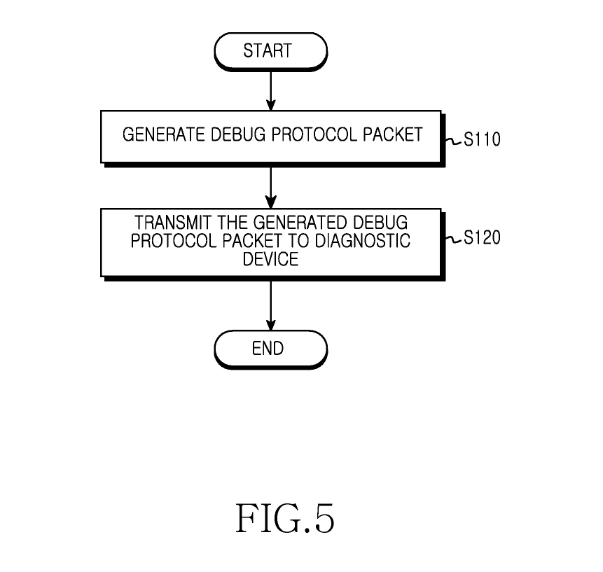

FIG. 5 is a flowchart illustrating a debugging processing method of a target device according to an embodiment of the present disclosure. This processing method can be conducted by the target device 100 of FIG. 4.

Referring to FIG. 5, the processor 110 generates the debug information or a debug protocol packet in operation S110 and transmits the generated debug protocol packet to the diagnostic device 200 via the interface 120 in operation S120.

The debug protocol packet includes reference information for at least one string associated with the debug trace. For example, the string can include the string specified in the print statement. The reference information includes an index indicating the string. Alternatively, the reference information includes an address for pointing to the location of the string in the binary file. The debug protocol packet can further include at least one argument.

The processor 110 can combine target information including the strings and data associated with a trace loggin mechanism into a common memory area. The common memory area can be the static RO area. For example, the target information includes at least one of a format string specified in the print statement, constant strings used as the arguments in the print statements, file names, and any bookkeeping data. For example, the combining can be performed by a compiler using a combination of either #pragma pre processor directive or pragma operator and scatter load configurations.

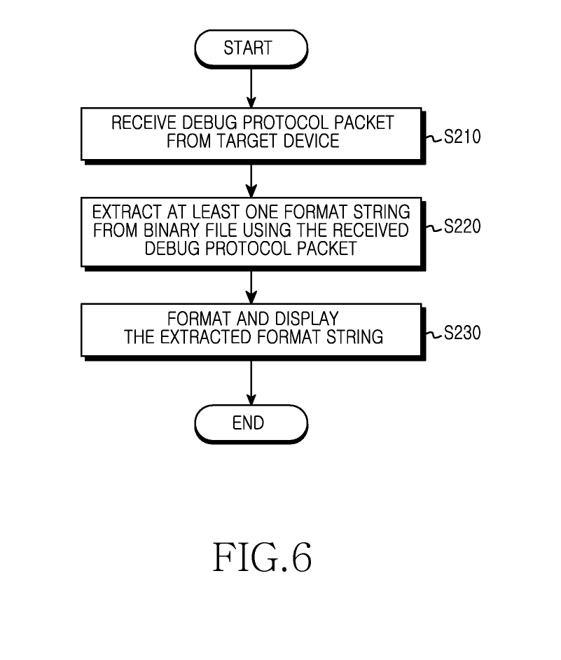

FIG. 6 is a flowchart illustrating a debugging processing method of a diagnostic device according to an embodiment of the present disclosure. This processing method can be conducted by the debug control module 210 of the diagnostic device 200 of FIG. 4.

Referring to FIG. 6, the debug control module 210 of FIG. 4 receives the debug protocol packet from the target device 100 in operation S210. The debug control module 210 extracts at least one string from the pre-input binary file using the received debug protocol packet in operation S220, and formats and displays the extracted string in operation S230.

The debug protocol packet includes the reference information of the string associated with the debug trace. For example, the string can include the string specified in the print statement. The reference information includes the index indicating the string. Alternatively, the reference information includes the address pointing to the location of the string in the binary file. The debug protocol packet can further include at least one argument.

Hereinafter, the performance optimization and the memory optimization by the debugging device are described.

### Performance Optimization

According to various embodiments of the present disclosure, the logging API in the process 110 of FIG. 4 does not format and transmit the print statement with the debugging information (or the protocol packet) within the target device 100 as shown in Table 1. Instead, the logging API transmits the reference information of the unformatted string as shown in Table 2. In so doing, the arguments can be transmitted along with the reference information of the string. For example, when the print statement (ANSI C) is “Completed initialization:% d” and its run time argument value is ‘0’, the reference of the unformatted string and the argument value ‘0’ are transferred to the diagnostic device 100 as shown in Table 2.

TABLE 1

| 0 | 1 | 2 | 3 | 4 | 5 | 6 | 7 |
|---|---|---|---|---|---|---|---|
| C | O | m | p | l | e | t | E |
| d | | i | n | i | t | i | A |
| l | I | z | a | t | i | o | N |
| : | 0 | | | | | | |

TABLE 2

| | | | | | | | |
|---|---|---|---|---|---|---|---|
| 0 | 1 | 2 | 3 | 4 | 5 | 6 | 7 |

| | |
|---|---|
| String Reference | 0 |

The formatting is carried out by the diagnostic device 200 so that the final print statement is visible on the diagnostic device 200 as “Completed initialization: 0”.

For example, the reference transferred over the logging interface can be an agreed index to ‘INDEX 1’ indicating the string “Completed initialization:% d” to be used at the diagnostic device 200. A table of such indexes is common and shared between the software on the target device 100 and the diagnostic device 200.

For example, the reference can be an address pointing to the physical location of the binary string. The diagnostic device 200 can generate an offset using a software image (binary file) and find the corresponding string present in the image (binary file).

As described above, since the formatting of the string associated with the debugging is offloaded to the diagnostic device, a significant processing gain can be attained. In addition, the size of the data to be transferred over the interface is notably reduced as shown in Table 1 and Table 2. In a test bend based on a mobile platform, a processing reduction gain around 85% per debug trace as shown in Table 3 is measured.

TABLE 3

| Parameter | Old method | Proposed method |
|---|---|---|
| Processing time | 20 uS | 3 uS |

The loggin information associated with the debugging is transferred from the software system, that is, from the target device 100 to the host based diagnostic monitor, that is, to the diagnostic device 200 as follows.

(A) The target device 100 generates the protocol packet including the address of the format string specified in the print statement, the number of arguments, and an argument list, each 4 bytes in size.

(B) The target device 100 transmits the generated packet to the diagnostic device 200 using the available interface (e.g., the UART, the USB, and the like) for the data transfer.

(C) The diagnostic device 200 takes the corresponding binary file (.bin) as the input.

(D) Using the reference information (e.g., the address) of the format string received, the diagnostic device 200 extracts actual format string from the input binary file.

(E) The diagnostic device 200 performs the actual display formatting using the extracted format string and the received argument list.

In the process (A), for the arguments of type ‘constant strings’, the target device 100 transfers only the address to the external diagnostic device 200, and the diagnostic device 200 in turn extracts the required string. In the process (A), the arguments of type ‘dynamic strings’ are passed completely (byte by byte, as hex dump) to the external diagnostic device 200, and the diagnostic device 200 in turn displays it in the required format. In the process (A), the passing of the number of the arguments can be avoided. In this case, the external diagnostic device 200 parses the extracted format string and computes the number of format specifiers.

In the operation (D), the binary is loaded into a non-zero base address, and the corresponding offset mapping is provided as the input to the external diagnostic device 200. The external diagnostic device 200 uses the offset information to extract the format string and the static string arguments.

For a dynamically loadable module, an address on which the binary is loaded at the run time is not known beforehand but will be indicated to the external diagnostic device 200 at the run time. This address is used by the diagnostic device 200 to extract the static strings (format/argument) from the binary.

The dynamic load time address indication can be a onetime message exchange between the target device 100 and the diagnostic device 200 at the beginning of the application. The dynamic load address information can be part of every log sent from target device 100 as part of a static header in a generic protocol between the target device 100 and the diagnostic device 200.

As described above, since the formatting in the target device 100 is completely avoided and offloaded to the external diagnostic device 200, the processing time consumed for the trace/logging mechanism in the target device 100 is reduced.

### Memory Optimization

In the software implementation for the cellular modem, the constant format strings greatly increase the memory overhead and thus need to be improved.

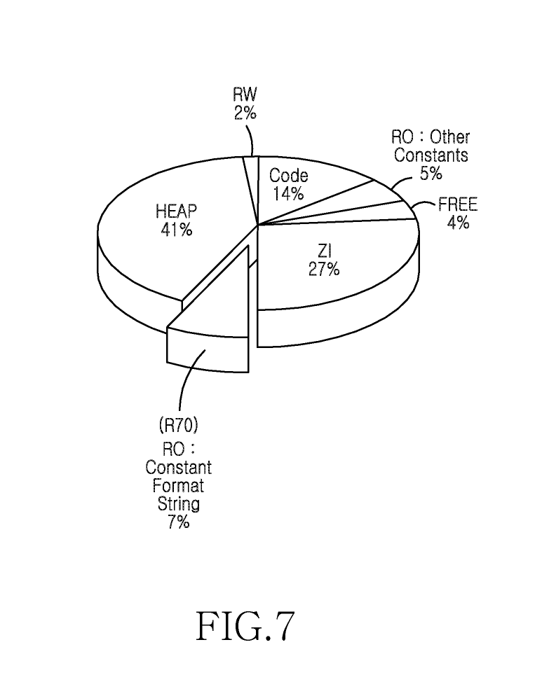

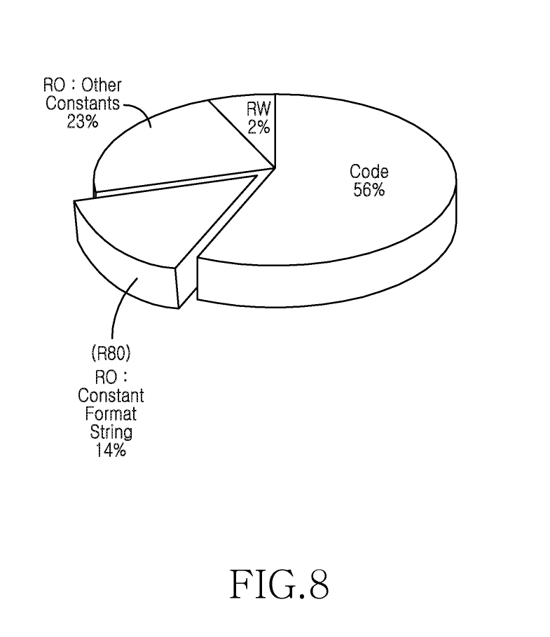

FIG. 7 illustrates constant format string occupancy in a total RAM space according to an embodiment of the present disclosure, and FIG. 8 illustrates constant format string occupancy in a total binary area according to an embodiment of the present disclosure.

Referring FIGS. 7 and 8, in the cellular modem software implementation, the constant format strings alone occupy 7% (R70) of the total RAM space as shown in FIG. 7 and occupy 14% (R80) of the total binary size as shown in FIG. 8. The debug strings linearly increase as and when new features/enhancements are added into the system, thus increasing the boot-up time in addition to the memory overhead.

According to an embodiment of the present disclosure, since the strings are not formatted until the reference information of the format string is transferred over the logging interface, there is no need to access contents of the unformatted string (other than the address or the reference) at the run time. Thus, the static memory occupied by the constant strings becomes redundant. The static memory of such format strings can be used for other purpose (e.g., the heap area R20 and the code area R60 in FIG. 3.)

Since the format strings are cluttered throughout the binary, the format strings need to be clubbed into a single area/cluster before re-claiming the area occupied by the strings. This can be achieved by using compiler specific syntax for grouping the constant strings together into a specific region. For example, ARM compiler can use #pragmas, _Pragma (“arm section rodata=\“TRAcE_sTRING_AREA\””).

All of the constant strings/data associated with the trace/logging mechanism in the target device 100 are combined into a common RO pool, that is, into the common memory area. In so doing, the combination of either #pragma pre processor directive or pragma operator and scatter load configurations can be used. The constant strings/data clubbed into the one pool can include the format string specified in the print statement, the constant strings used as the arguments in the print statements, the file names (to be usually part of a literal pool), or any bookkeeping data.

According to an embodiment of the present disclosure, the static RO area generated by offloading the trace log formatting job to another processor residing on the same device or another device is made redundant for the operation in the target device. For example, the static RO area pool is never accessed during the run time of the device. Only the address of the strings is passed to the diagnostic device. The static RO area pool can be reused at any time as the heap/stack/any other form of the memory usage. The static RO area pool is not part of the binary loaded into the device. Hence, the pool area is automatically re-claimed for any type of reuse (heap/stack/program).

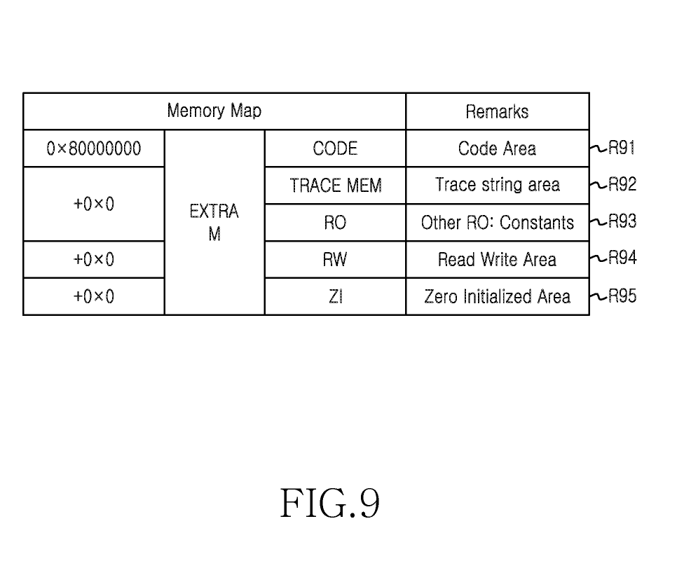

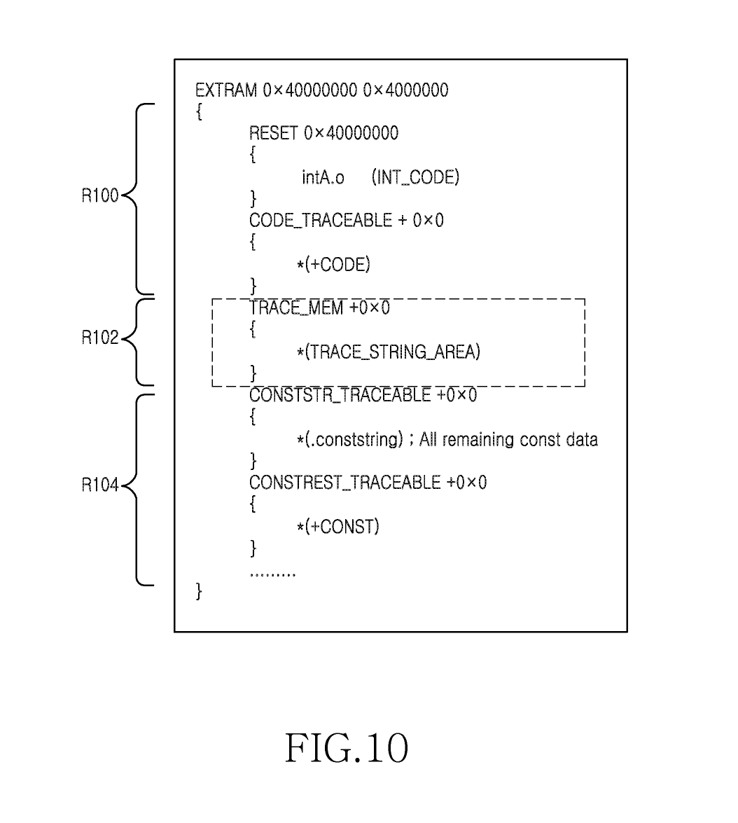

FIGS. 9 and 10 illustrate trace strings grouped and placed in a specific memory area according to various embodiments of the present disclosure.

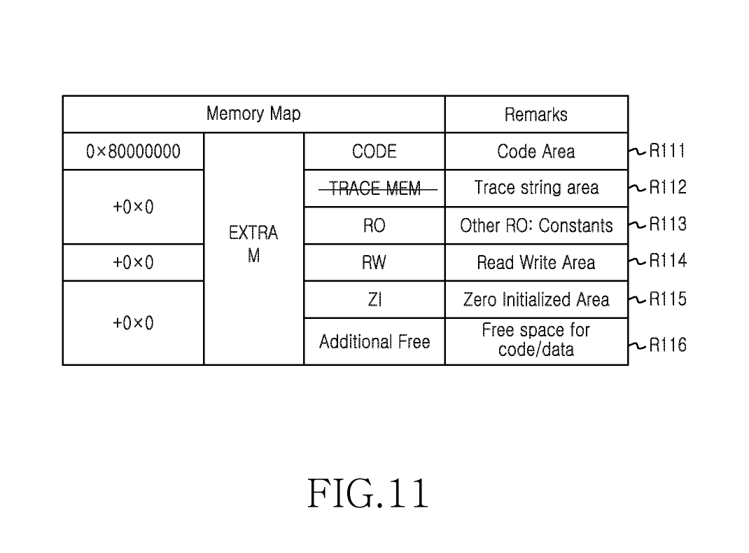

FIGS. 11, 12, 13, 14, 15, 16, 17, and 18 illustrate the reuse of the specific memory area containing the grouped trace strings according to various embodiments of the present disclosure.

The regions for storing the trace strings can be grouped together at the linking time by a linker specific scatter loader as shown in FIG. 10, and the trace string region (TRACE_MEM of FIG. 9) can be placed in a contiguous memory area.

Referring to FIG. 9, the memory (e.g., the RAM) is divided into a code area R91, an R92 as the trace string area R0, an R93 as other RO area for storing the constants, a read write area R94, and a zero initialized area R95.

Referring to FIG. 10, the linker specific scatter loader scatters and loads a code area R100, a TRACE STRING area R102, and other constants area R104.

The trace string region TRACE_MEM can be reused as in a), b), and c).

a) Run time dynamic memory pool after boot up initialization is over. FIG. 11 illustrates such a scenario.

Referring to FIG. 11, the memory (e.g., the RAM) is divided into a code area R111, an R112 as the trace string area R0, an R113 as other RO area for storing the constants, a read write area R114, a zero initialized area R115, and a free space R116. A Zero Initialized (ZI) area R115 overwrites the string area R112 at the run time.

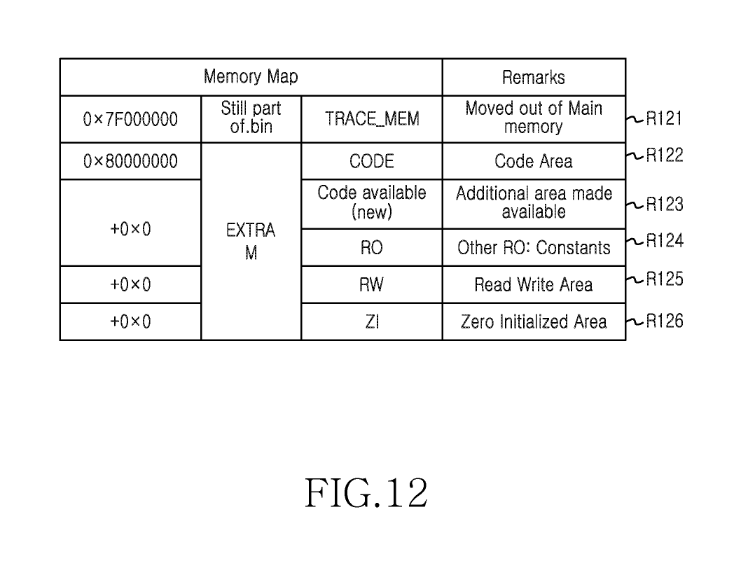

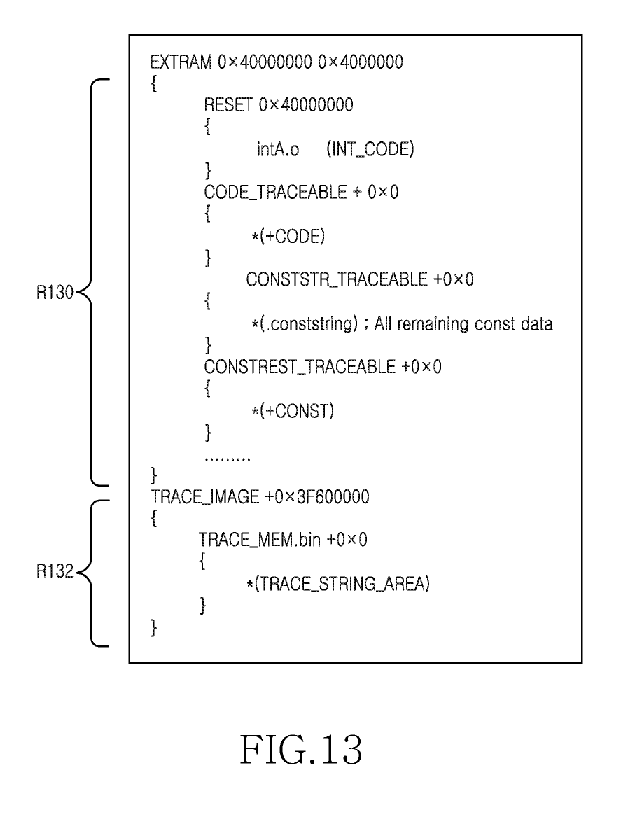

b) It can be even moved out of the main memory map using the linker specific scatter loading technique, so that it does not occupy any RAM area. FIGS. 12 and 13 illustrate this scenario.

Referring to FIG. 12, the memory (e.g., the RAM) is divided into a code area R122, an additional available area R123, an R124 as other RO area for storing the constants, a read write area R125, a zero initialized area R126, and a moved string area R121. Scatter loading moves the trace string area out of the RAM areas R122 through R126.

Referring to FIG. 13, a string area R132 is moved from a RAM area R130. TRACE_MEM continues to be part of the software image (e.g., a binary file), and accordingly the diagnostic device can use the binary file to resolve the reference to the unformatted string passed in the debug trace.

c) In an alternative solution for the memory reuse, a concept of OVERLAY can be exploited, which can be exemplified using scatter loading principles for the ARM based test bed.

An embodiment of the present disclosure defines a ‘Fixed or Pre-loaded Overlay’, where there is no need for an overlay manager to exist and the initial loading of the region is processed by the general scatter loader functionality found in the standard initialization library.

‘OVERLAY’ attribute can be used in the scatter file so as to place multiple code/data blocks at the same memory location. Generally, linker causes an error when more than one memory region have the same memory address. When the memory region is specified with the OVERLAY attribute in the scatter file, the code or data to be placed in this region will be linked. However, the loading of code/data in the execute region needs to be managed by the overlay manager at the run time.

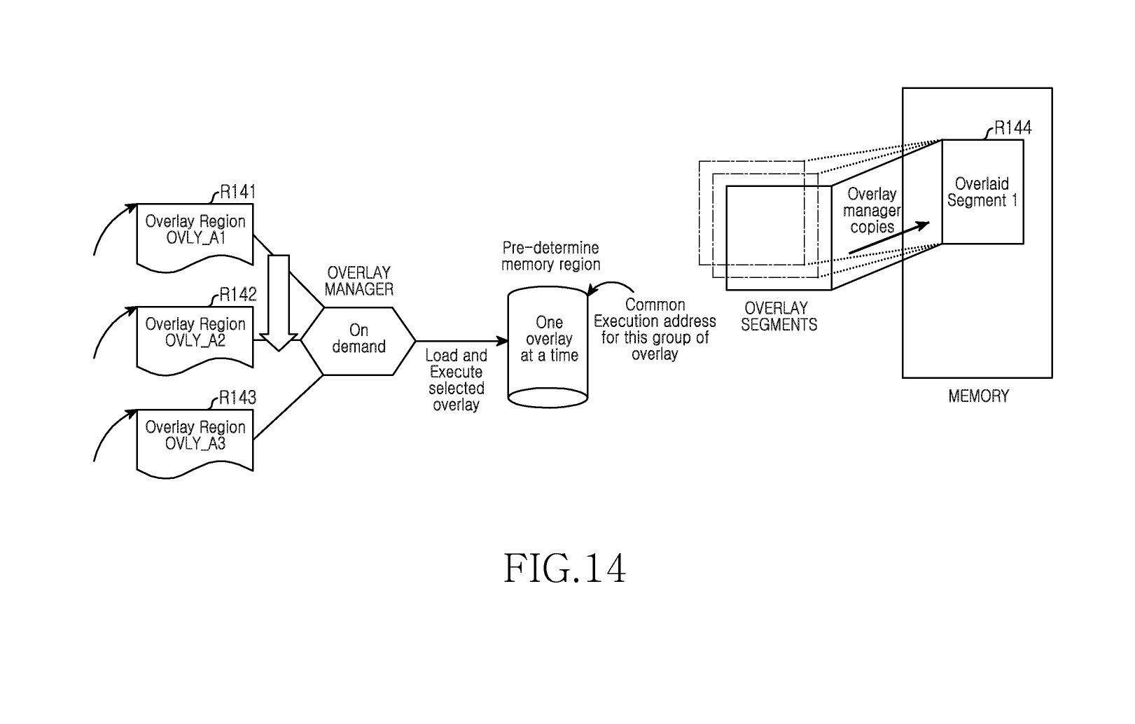

Referring to FIG. 14, the OVERLAY concept, where regions R141, R142, and R143 marked as the overlays can be swapped by the overlay manager on a need basis is illustrated. R144 indicates a segment overlaid with a particular memory region by the overlay manager. Such overlay is a dynamic process and utilized in some of old operating systems, such as RSX before demand paging is widely adopted.

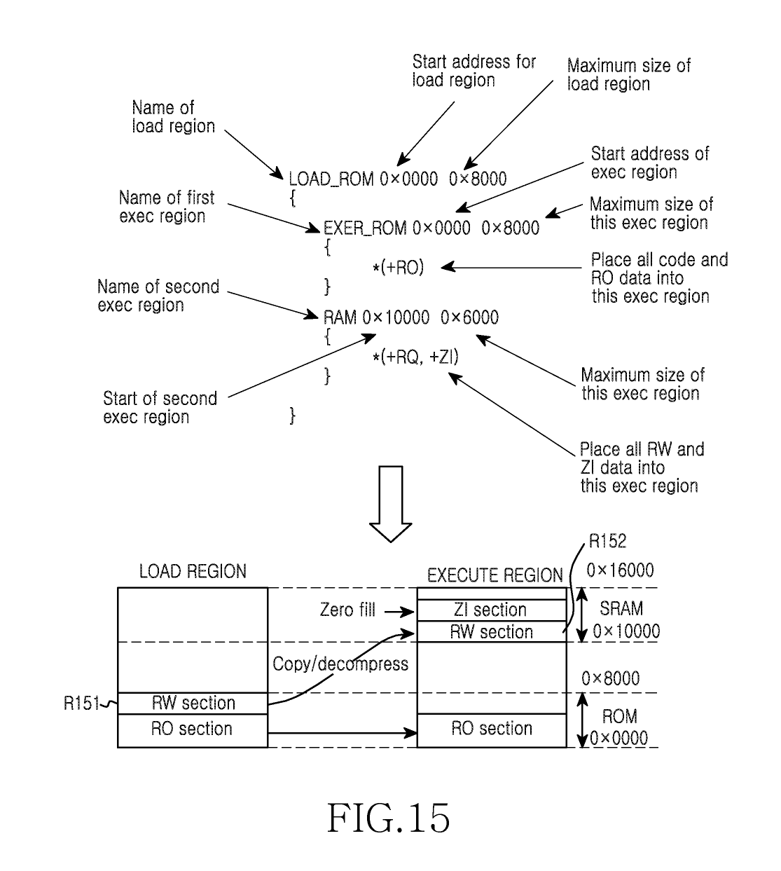

Referring to FIG. 15, regions R151 and R152 called RAM2 (including Read/Write (data) and ZI (bss)) are illustrated. FIG. 15 illustrates a typical scatter-loading concept based on a scatter loader description file for the ARM, where the initial copy from a load region to an execute region is processed by the scatter loader functionality in the initialization/boot up sequence routine.

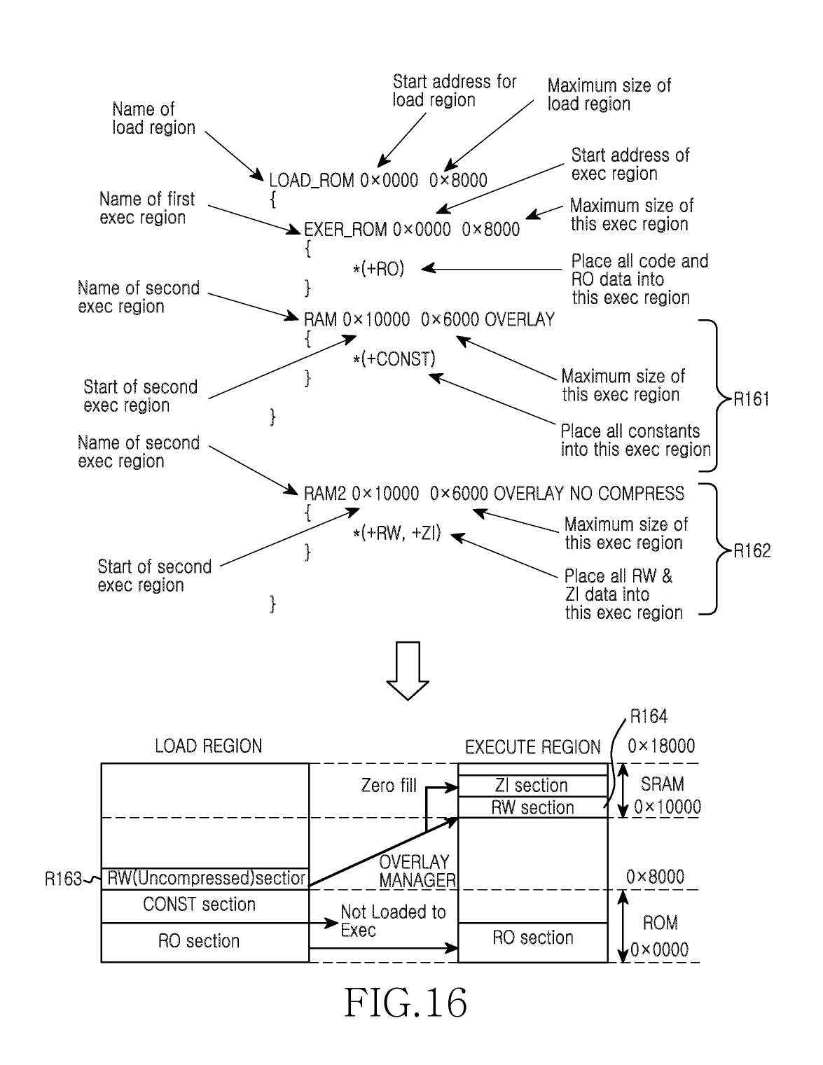

Referring to FIG. 16, however, when a region has the ‘OVERLAY’ attribute, it needs to be loaded by the overlay manager. In this case, regions R161 and R163 called as RAM1 (including Constants) and regions R162 and R164 called as RAM2 (including Read/Write (data) and ZI (bss)) are overlaid and have the same execute address 0x10000.

When the ‘TRACE_MEM’ region is overlaid with the ZI region, it is possible to avoid the need for dynamism associated with the overlay swapping because ‘TRACE_MEM’ is the redundant memory region. Such redundancy ensures that it is never required during the execution.

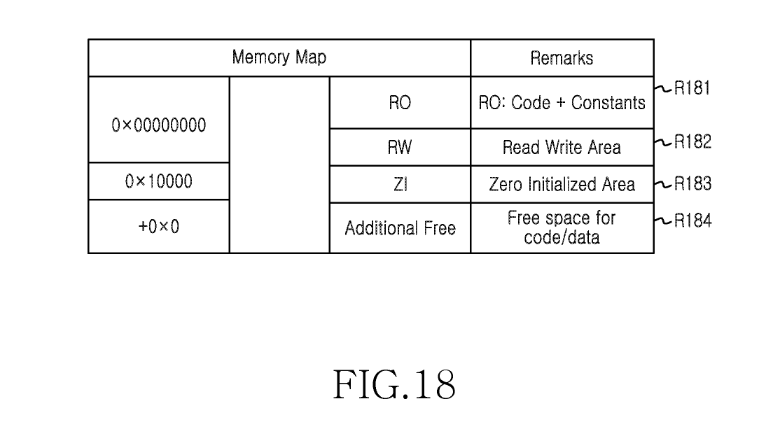

According to the concept called ‘Fixed or Pre-loaded Overlay’, there is no need for the overlay manager to exist and the initial loading of the region is processed by the general scatter loader functionality found in the standard initialization library. Conceptually, this scheme can be used in cases, when only the memory reuse (dual use) is expected, and perhaps a dynamic change of contents of the overlay region is not expected (though allowed). This is depicted in FIG. 18.

Referring to FIG. 18, the memory (e.g., the RAM) is divided into an R181 area as other RO area for storing code and the constants, a read write area R182, a zero initialized area R183, and a free space R184.

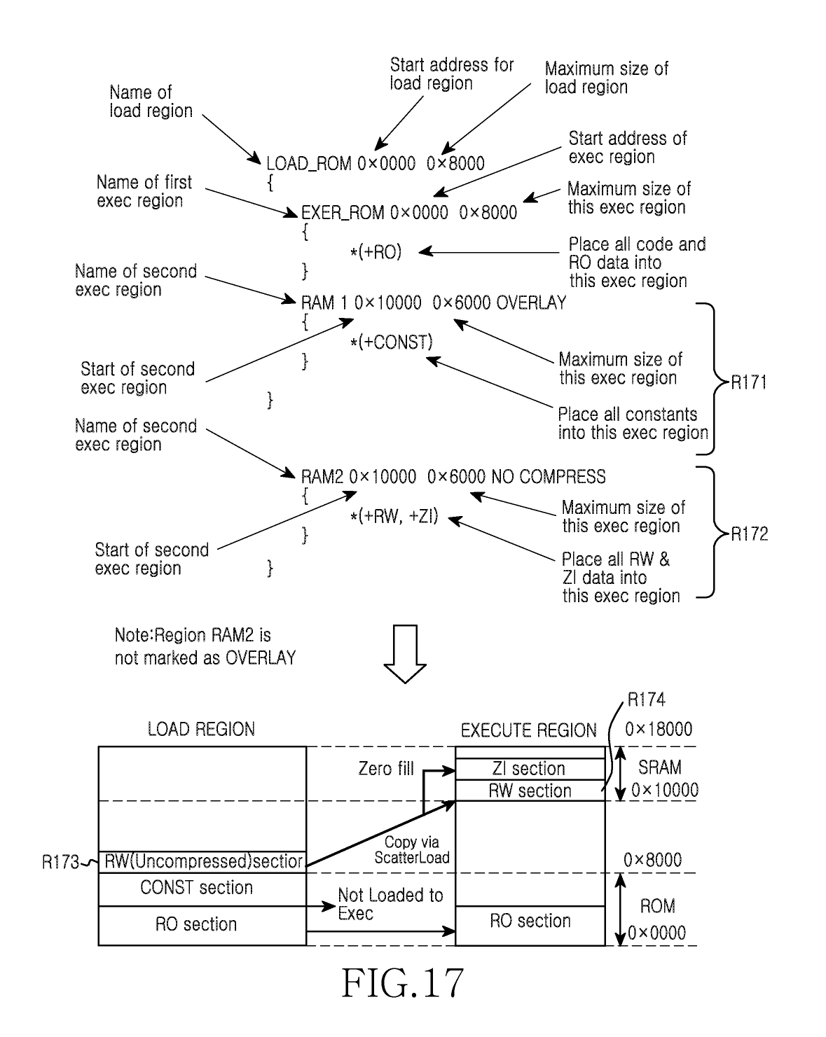

Referring to FIG. 17, regions R171 and R173 called as RAM1 (including Constants) and regions R172 and R174 called as RAM2 (including Read/Write (data) and ZI (bss)) are overlaid and have the same execute address 0x10000.

In order to realize this concept, the regions RAM1 and RAM2 R171 and R172 share the same execute address even though the region RAM2 R172 does not have the ‘OVERLAY’ attribute. Using this mechanism, the copy from the load region to the execute region for the RAM2 is processed by the scatter loader functionality in the initialization/boot up sequence as part of the normal standard procedure as shown in FIG. 18.

By virtue of the present mechanism for the combined processing and the memory optimization deployed in the debug trace management, huge memory footprint induced by the debug trace logs can be reduced. In addition, the restriction on the size/length of the format string can be removed as the processing time remains the same for all logs irrespective of their length. Such implementation can attain around 85% processing gains and around 100% memory gains in the logging utility of the embedded software. Therefore, it is expected that the development cost can be reduced and the systems scalability can be improved to meet future incremental requirements.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating a debugging target device, the method comprising:
generating a debug protocol packet; and
transmitting the debug protocol packet to a diagnostic device,
wherein the debug protocol packet comprises reference information regarding at least one string associated with a debug trace.

2. The method of claim 1, wherein the at least one string comprises a string specified in a print statement.

3. The method of claim 1, wherein the reference information comprises at least one of an index indicating the at least one string and an address indicating a location of the at least one string in a binary file.

4. The method of claim 1, wherein the debug protocol packet further comprises at least one argument.

5. The method of claim 1, further comprising:
combining target information comprising the at least one string and data associated with a trace logging mechanism into a common memory area.

6. The method of claim 5, wherein the common memory area comprises a statistic read only (RO) area.

7. The method of claim 5, wherein the target information comprises at least one of a format string specified in a print statement, constant strings used as arguments in the print statement, file names, or any bookkeeping data.

8. The method of claim 7, wherein the combining is performed by a compiler using a combination of either #pragma pre processor directive or a pragma operator and scatter load configurations.

9. A method for operating a debugging diagnostic device, the method comprising:
receiving a debug protocol packet from a target device;
extracting at least one string from a pre-input binary file using the debug protocol packet; and
formatting and displaying the at least one string,
wherein the debug protocol packet comprises reference information regarding the at least one string associated with a debug trace.

10. The method of claim 9, wherein the at least one string comprises a string specified in a print statement.

11. The method of claim 9, wherein the reference information comprises at least one of an index indicating the at least one string and an address indicating a location of the at least one string in a binary file.

12. The method of claim 9, wherein the debug protocol packet further comprises at least one argument.

13. A target device in a debugging system, the target device comprising:
a processor configured to generate a debug protocol packet; and
an interface configured to transmit the debug protocol packet to a diagnostic device,
wherein the debug protocol packet comprises reference information regarding at least one string associated with a debug trace.

14. The target device of claim 13, wherein the at least one string comprises a string specified in a print statement.

15. The target device of claim 13, wherein the reference information comprises at least one of an index indicating the at least one string and an address indicating a location of the at least one string in a binary file.

16. The target device of claim 13, wherein the debug protocol packet further comprises at least one argument.

17. The target device of claim 13, wherein the processor further combines target information comprising the at least one string and data associated with a trace logging mechanism into a common memory area.

18. The target device of claim 17, wherein the common memory area comprises a statistic read only (RO) area.

19. The target device of claim 17, wherein the target information comprises at least one of a format string specified in a print statement, constant strings used as arguments in the print statement, file names, or any bookkeeping data.

20. The target device of claim 19, wherein the processor is further configured to combine the target information comprising the at least one string and the data into the common memory area using a combination of either #pragma pre processor directive or a pragma operator and scatter load configurations.

21. The target device of claim 13, wherein the diagnostic device is included in a host computer separated from the target device.

22. A diagnostic device in a debugging system, the diagnostic device comprising:
an interface configured to receive a debug protocol packet from a target device; and
a debug control module configured:
to extract at least one string from a pre-input binary file using the debug protocol packet, and
to format and display the extracted at least one string,
wherein the debug protocol packet comprises reference information regarding the at least one string associated with a debug trace.

23. The diagnostic device of claim 22, wherein the at least one string comprises a string specified in a print statement.

24. The diagnostic device of claim 22, wherein the reference information comprises at least one of an index indicating the at least one string and an address indicating a location of the at least one string in a binary file.

25. The diagnostic device of claim 22, wherein the debug protocol packet further comprises at least one argument.

26. The diagnostic device of claim 22, wherein the diagnostic device is included in a host computer separated from the target device.

27. At least one non-transitory computer readable storage medium for storing a computer program of instructions configured to be readable by at least one processor for instructing the at least one processor to execute a computer process for performing the method of claim 1.
